(19) United States
(12) Patent Application Publication
(10) Pub. No.: US 2018/0181646 A1
(43) Pub. Date: Jun. 28, 2018

(54) SYSTEM AND METHOD FOR DETERMINING IDENTITY RELATIONSHIPS AMONG ENTERPRISE DATA ENTITIES

(71) Applicant: Infosys Limited, Bangalore (IN)

(72) Inventors: Gopi Krishna Balasa, Hyderabad (IN); Sujoy Kanti Ghosh, Burdwan (IN); Radha Krishna Pisipati, Hyderabad (IN)

(73) Assignee: Infosys Limited, Bangalore (IN)

(21) Appl. No.: 15/795,047

(22) Filed: Oct. 26, 2017

(30) Foreign Application Priority Data
Dec. 26, 2016 (IN) 201641044312

(51) Int. Cl. G06F 17/30

(52) U.S. Cl. CPC G06F 17/30604; G06F 17/30598

(57) ABSTRACT

A method and/or system for identity relationship determination among enterprise data entities to extend master data management is disclosed. The method involves extracting the data from the one or more data sources, thereafter grouping the extracted data into one or more groups based on one or more predefined criteria, then computing a plurality of relationship scores by using one or more soft matching techniques, thereafter creating one or more clusters based on the computed relationship scores, then again calculating a plurality of relationship scores among the clusters, and finally, determining the identity relationships by comparing the plurality of relationship scores generated among clusters with a predefined score.

### FIELD

The technical field relates to data management. In particular, the present disclosure relates to a method and a system for identity relationship determination among enterprise data entities to extend master data management.

### BACKGROUND

In enterprise scenarios, information is stored in huge volumes in diversified (heterogeneous) sources. The data is stored in the form of relational tables (structured) and documents (semi-structured/unstructured) for an enterprise, and the number of tables/documents (few hundreds) and size of the data (big data scale) are very high. However, the relationships that exist among these data elements or entities are not initially known. System designers usually use domain knowledge to establish such relationships. For legacy systems, design-time information is usually not available in the organizations.

Also, there is no technology that exists to automatically discover or determine data identity relationships that represent business semantics and processes from the enterprise data (both unstructured and structured data) for effective utilization of the enterprise information.

As organizations grow and evolve, new system requirements arise and thus necessitate development of new applications. Lack of underlying information or knowledge at design-level about the relationships among data elements/entities is a major challenge, especially for master data management and meta data management. Additionally, the data from two or more data sources that may or may not share common properties/identifiers (e.g., primary key, foreign key, etc.) and the differences among an entity representations are due to time and location of data posting, data curation, and use or development of different applications, technologies, and infrastructures over a period of time. So, it becomes difficult to identify identity relationships or linkage among huge amounts of enterprise data. Therefore, there is a need for a robust system to handle such problems.

### SUMMARY

Disclosed are a method, a system and/or a non-transitory computer readable storage medium for determining identity relationships among two or more enterprise data entities. Although the present embodiments have been described with reference to specific example embodiments, it will be evident that various modifications and changes may be made to these embodiments without departing from the broader spirit and scope of the various embodiments.

In one or more embodiment of the invention, a method for identity relationship determination among enterprise data entities to extend master data management is disclosed. The method involves extracting an enterprise data from one or more data sources. Thereafter, grouping, the extracted data into one or more groups based on one or more predefined criteria. Further, computing a plurality of relationship scores wherein, the step comprises matching one or more data entities in the grouped data then calculating a plurality of relationship scores of the matched entities by using one or more soft matching techniques thereafter clustering the data into one or more clusters based on the calculated relationship score and finally obtaining the relationship scores among the clusters by repeating process of relationship score calculation. Finally, determining the identity relationships by comparing the plurality of relationship scores generated among the clusters with a predefined score.

In one embodiment of the invention, a system for identity relationship determination among enterprise data entities is disclosed. The system comprises an extraction engine, a grouping engine, a computation engine, an identity relationship determination engine and one or more processors and one or more memories operatively coupled to at least one of the one or more processors and having instructions stored thereon.

The one or more processors are configured to extract, at the extraction engine, an enterprise data from one or more data sources. Thereafter group, at the grouping engine, the extracted data into one or more groups based on one or more predefined criteria. Then compute, at the computation engine, a plurality of relationship scores wherein, the step comprises:

match one or more data entities in the grouped data; calculate a plurality of relationship scores of the matched entities by using one or more soft matching techniques; cluster the data into one or more clusters based on the calculated relationship score and obtain the relationship scores among the clusters by repeating process of relationship score calculation. Finally, determine, at the identity relationship determination engine, the identity relationships by comparing the plurality of relationship scores generated among the clusters with a predefined score.

In another embodiment, a non-transitory computer readable medium for identity relationship determination among enterprise data entities is disclosed. This involves a non-transitory computer readable medium having stored thereon instructions for extracting an enterprise data from one or more data sources. Thereafter, grouping, the extracted data into one or more groups based on one or more predefined criteria. Further, computing a plurality of relationship scores wherein, the step comprises matching one or more data entities in the grouped data then calculating a plurality of relationship scores of the matched entities by using one or more soft matching techniques thereafter clustering the data into one or more clusters based on the calculated relationship score and obtaining the relationship scores among the clusters by repeating process of relationship score calculation. Finally, determining the identity relationships by comparing the plurality of relationship scores generated among the clusters with a predefined score.

In one or more embodiments, the enterprise data may comprises of structured, unstructured, semi-structured or mixed data.

The method, the system and/or the non-transitory computer readable storage medium disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a diagrammatic representation of a preferred embodiment of an identity relationship determination system capable of processing a set of instructions to perform any one or more of the methodologies described herein, according to one or more embodiments;

FIG. 2 is a preferred embodiment of a process flow diagram illustrating a method for determining identity relationships among enterprise data entities, according to one or more embodiments;

FIG. 3 is a preferred embodiment of a flow diagram, illustrating the flow for computing a plurality relationship scores by matching one or more entity name, attribute name and values using one or more soft matching techniques, according to one or more embodiments; and

FIG. 4 is a preferred embodiment of a flow diagram, illustrating the flow of soft matching technique, according to one or more embodiments.

### DETAILED DESCRIPTION

Example embodiments, as described below, may be used to provide a method, a system for identity relationship determination among enterprise data entities. Although the present embodiments have been described with reference to specific example embodiments, it will be evident that various modifications and changes may be made to these embodiments without departing from the broader spirit and scope of the various embodiments.

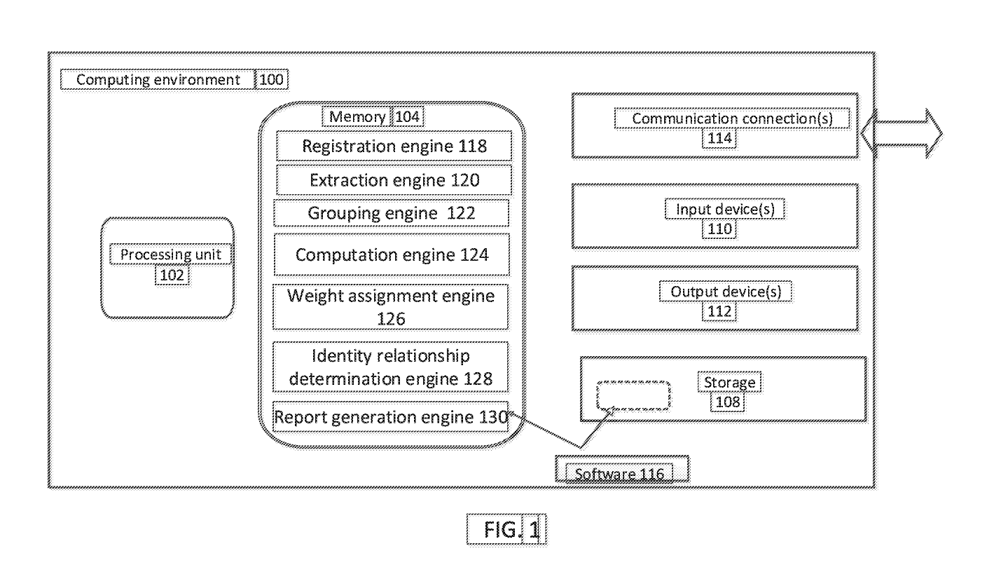

FIG. 1 is a block diagram illustrating an apparatus for identity relationship determination among enterprise data entities related to system description in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software or program 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

The processor 102 executes a program of stored instructions for one or more aspects of the present technology as described and illustrated by way of the examples herein, although other types and numbers of processing devices and logic could be used and the processor could execute other numbers and types of programmed instructions. The memory 104 stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 102, can be used for the memory 104.

The memory 104 also includes program for identity relationship determination among enterprise data entities related to system description. The system also includes a registration engine 118, an extraction engine 120, a grouping engine 122, a computation engine 124, a weight assignment engine 126 an identity relationship determination engine 128 and a report generation engine 130. The extraction engine 120, extracts an enterprise data from one or more data sources. The grouping engine 122, groups the extracted data into one or more groups based on one or more predefined criteria. The computation engine 124, computes a plurality of relationship scores. The plurality of relationship scores are computed wherein one or more data entities in the grouped data are matched then a plurality of relationship scores of the matched entities are calculated by using one or more soft matching techniques thereafter the data is clustered into one or more clusters based on the calculated relationship score and finally the plurality relationship scores are obtained among the clusters by repeating process of relationship score calculation. The identity relationships determination engine 128 determines the identity relationships by comparing the plurality of relationship scores generated among clusters with a predefined score. The registration engine 118 configured to register the enterprise data sources received from one or more data sources before extracting the data. The report generation engine 130 configured to generate a report of the determined relationships. The weight assignment engine 126 configured to assign a dynamic weights during each step of the soft matching techniques.

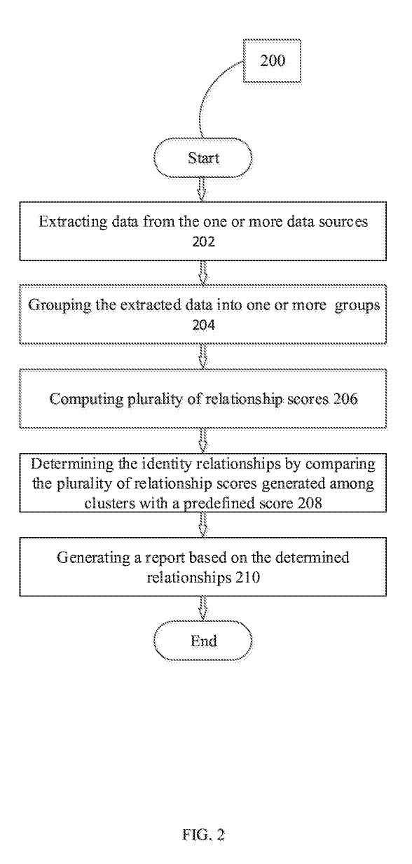

FIG. 2 is a process flow diagram illustrating a method for determining identity relationships among enterprise data entities, according to one or more embodiments of the invention. The method involves extracting an enterprise data from one or more data sources 202. Thereafter, the extracted data is grouped into one or more groups based on one or more predefined criteria 204. Then, a plurality of relationship scores are calculated 206. The plurality relationship scores are calculated by matching one or more data entities in the grouped data. Then calculating a plurality of relationship scores of the matched entities by using one or more soft matching techniques. Thereafter, clustering the data into one or more clusters based on the calculated relationship score. And obtaining, the relationship scores among the clusters by repeating process of relationship score calculation. Finally, the identity relationships are determined by comparing the plurality of relationship scores generated among clusters with a predefined score 208. Finally, a report of the determined identity relationships is generated 210.

According to one or more embodiment of the invention, the entity is an object or thing which represented by a name which is a string of characters/numbers. In context of the invention, it pertains to data in an enterprise. For instance: database, table, document, row, column, tag, metadata (i.e., data describing other data), etc. The identity relationships are relationships which pertains to identity of the data. The data present in database in diverse form without any known inter-relation or connecting logic. Hence in order to derive logic and inter-relation from the diversified data, identity relationships are determined. The enterprise data is present in enterprise databases in huge volume and diversified form. The sources of data is not limited to structured databases (e.g., relational databases, NoSQL databases etc.), semi structured databases (e.g., email, filled forms/documents etc.), unstructured databases (e.g., text files, scanned documents, images, policies etc.) or mixed databases which may contain combination of structured, semi-structured or unstructured data. The data resides in various data sources of enterprise system. In order to extract the data, a connection to the data source is established. The connection is a part of a connection layer which contains one or more adaptors to connect to the data sources or make connection with data sources in order to ease the data extraction. The different types of adaptors includes but not limited to Open Database Connectivity (ODBC), Java Database Connectivity (JDBC) or Object Linking and Embedding, Database (OLDB) for structured data sources; parsers for semi structured data sources and OCR for unstructured data sources.

According to one embodiment of the invention, once the connection is established, the enterprise data sources received from one or more data sources are registered wherein registration involves registering or storing a connection credentials of all data sources. The connection credentials involves the details related to type of data sources. For instance, for structured databases or data sources, Server Name, Database Name/Schema Name, User ID & Password are stored. For Semi Structured databases or data sources, XML file path and Schema Definition file path, Email Address, Web Page URL or file path of saved Email/URL content etc. are stored. For Unstructured databases or data source, exact file path with file name is stored. The registration is usually a onetime process for each of the data sources intended to be used for identity relationship discovery/determination. Since, organization data evolves and new data sources add to the enterprise, the registration process is repeated to start the identity relationship determination process with a new set of data. After registration, data is extracted from the data sources 202 using various approaches depending upon the type of data/data sources.

In one or more embodiments, the data may be in structured, semi-structured, unstructured or in mixed format. Hence in order to identify entities in various types of data, different approaches are used. According to an exemplary embodiment of the invention, the data from relational tables is extracted using Structured Query Language, whereas data from unstructured and semi-structured documents is extracted using Natural Language Processing (NLP) parsers, XML parsers, NLP techniques (such as tokenization, stemming and stop-word removal) and computational linguistics. For semi-structured documents, tagging information is used to extract the entities. In the case of image documents, first OCR (Optical Character Recognition) is applied to convert the image content into text and then apply NLP techniques on the extracted text. The Named Entity Recognition (NER) is used to recognize and extract entities from unstructured documents. There are two ways to perform NER: (i) Rule-based and (ii) Learning based. In the rule-based, a set of rules are defined with an added context. For instance, to identify the promotion date in an employment promotion letter, a string in the date format that has prefix as ‘effective date’. Since the date can be represented in multiple formats (e.g. dd/mm/yyyy; mm-dd-yyyy and Month Name day, year (Aug. 1, 2015)), regular expressions are used. The regular expression is a sequence of characters and/or symbols expressing a string or a search pattern. Examples: (0[1-9]|1[012])[−/.](0[1-9]|[12][0-9]|3[01])[−/.](19|20)\d\d (date in mm/dd/yyyy format) and 999.999.999.999 (IP address) which is used to validate the required string. Another approach used is neighbourhood technique to recognize an entity string within a sentence/text. The neighbourhood technique looks at specified number of words before and/or after the string like prefix and suffix strings and constraints on the number of words for prefix and suffix terms. For instance, a date with a prefix of two words as ‘effective date’ is recognized as Effective date of promotion.

In the learning based approaches, a classification algorithm (based on Term frequency and Inverse Document Frequency (TF-IDF) features) is applied on the enterprise data where the known entity values are tagged and create a classification model. The classification model is used for recognizing entities from new documents.

According to an embodiment of the invention, the data is extracted from the data sources 202 into a staging area which may be central or distributed or cloud based for further processing. The staging area is an intermediate storage area that is used to store or capture required data from different sources to carry out further processing like data transformation, data quality enrichment and reporting. The staging area is used to do data processing activities in most of the cases because, there might be limited access (read-only) to a source system or there may be different data sources which are not similar on their data structure definition hence, standard processing logic may not be implemented on all the data sources at a time.

Thereafter, the extracted data is grouped into one or more groups based on one or more predefined criteria 204. The one or more predefined of criteria includes, but not limited to, sorting alphabetically and dividing, hashmap, etc. Since data is present in huge volume general grouping or division or segregation of data ease the further processing.

According to an embodiment of the invention, once data is grouped into one or more groups, a plurality of relationship scores are computed by matching one or more data entities in the grouped data, thereafter calculating a plurality of relationship scores of the matched entities by using one or more soft matching techniques then clustering the data into one or more clusters based on the calculated relationship score and obtaining, the relationship scores among the clusters by repeating process of relationship score calculation 206. The matching one or more data entities in the grouped data comprises matching one or more entities, attributes and values using one or more sot matching techniques. Then, the identity relationships are determined by comparing the plurality of relationship scores generated among clusters with a predefined score 208. Finally, a report is generated which depicts the identity relationships of the data sources 210. The report is customizable based on the requirement.

### Full Process

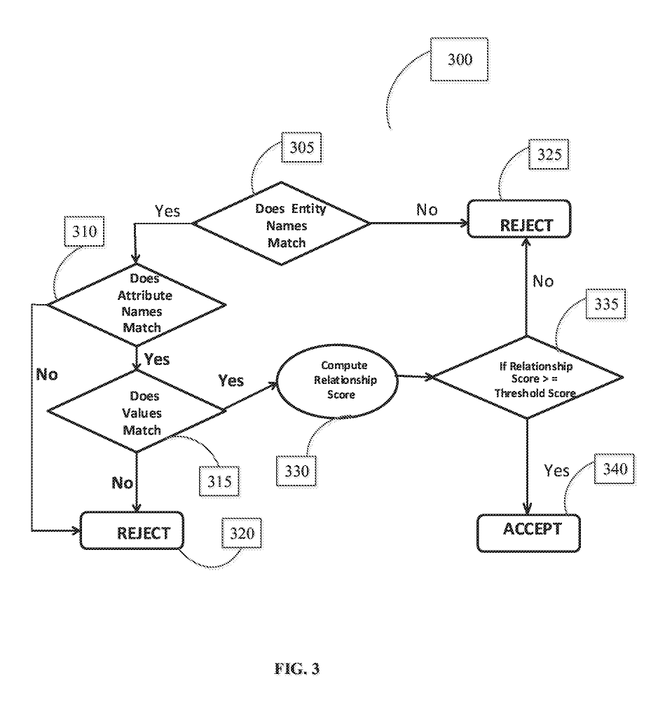

FIG. 3 is a flow diagram, illustrating the flow for computing a plurality of relationship scores by matching one or more entity name, attribute name and values using one or more soft matching techniques 300. The entity is an object or thing which represented by a name which is a string of characters/numbers. In context of the invention, it pertains to a specific or particular aspect of data in an enterprise. For instance: database, table, document, row, column, tag, metadata (i.e., data describing other data), etc. The attributes basically related to specifics of entities such as qualities, features, dimensions or properties of the entities. For instance, for an entity table, attribute represent a column (also called ‘field’).

According to an exemplary embodiment of the invention, for an entity as document, attributes are properties of document such as size, file name, words in the document, number of times a word occurs in the document, etc. For an e-mail, attributes may include sender, receiver, mail-IDs in the CC/BCC, signature, etc. The values are string of characters/numbers that may be placed as an instance of attribute. For example, in a database table, attribute is a column name, and the data stored in that column are values. Like Employee number is a column, whereas all the employee numbers stored under that column are values.

In one or more embodiments, the process of a plurality of relationship score generation involves iterative process of matching entity 305 in the grouped data (between two or more groups), firstly entity name with exact word match is matched, and if it is failed then it is taken ahead for soft matching techniques. If soft match also fails then data is rejected 325 and considered as not related. If entity matches, say Entity 1 and Entity 2 are two entities and if both matches then a match score is generated. If the match score is equal to or more than a predefined threshold score/value then Entity 2 is passed to next step to match attribute 310. The threshold score/value is a number that is used to define acceptable/allowed values for a parameter which must be exceeded for a certain phenomenon to trigger or to satisfy a condition. The parameters may be part of an equation or value of an attribute. The threshold score/value is represented in terms of percentage. The threshold score/value is predefined. In next step (2) each attribute names of Entity 1 with all attributes of Entity 2 are matched, firstly using exact word comparison and then soft match technique subsequently to find out match percentage or match score between 2 attributes names. If the match score is more than or equal to the threshold score/value then it is passed to next step. If attribute does not match, the data is rejected 320 considered as not related. If attributes matches, process further proceed to match values 315. In this step (3) values of Entity 2 attributes from the above 2 entities where attribute names matches in step 2. Each value of Attribute1 is compared with all values of Attribute 2. Again initially exact words are matched followed by soft matching techniques to obtain a final score which is relationship score. If relationship score is more than or equal to a predefined score or value then it is considered as a match or related entities. The predefined score is an acceptable/allowed values. If relationship score is below than predefined score then relationship is rejected. If relationship score is more than or equal to predefined value then relationship is accepted. The relationship score is a final score obtained by iteratively matching all the entities, attributes and values present in a particular data source or group of data. All the obtained related entities or matched entities creates a cluster, hence clusters are created based on the matched entities. Similarly, one or more clusters are generated based on the obtained relationship scores of the matched entities. Further, match scores among all the clusters are calculated and final relationship scores are generated. The relationship scores are compared with a predefined score to determine identity relationships in data/data sources. Hence, the relationship score is calculated 330 as

Total no. of Matches divided by Total No. of Records

If this relationship score is more than a predefined score then it is considered as two elements are related by these attributes and with Relationship Strength equal to a computed relationship score. The relationship strength is used to define/qualify the relationship score that is computed between two entities. Higher the relationship score, larger is the relationship strength. If score does not match, the data is rejected 320 considered as not related.

According to an exemplary embodiment of the invention, if EMP and EMPL are 2 entities which are partially matched by their names as depicted in Table 1.1. EMP has an attribute ENAME and EMPL has an attribute EMPNAME which are partially matched by their names. A match score is calculated between these two attributes. The attribute ENAME contains 3 records and attribute “EMPNAME” contains 5 records. For each values of ENAME, 5 values of EMPNAME are compared. For value “Fred” of ENAME, 2 partial matches out of 5 values from EMPNAME are found. Hence, match score is 70% and 60%. If threshold score is considered as 60% then there are 2 matches. Similarly, 1 and 1 matches are found for other 2 records of ENAME while comparing all 5 values of EMPNAME. (Refer Table 1.1).

Relationship Score(EMP.ENAME,EMPL.EMPNAME)=100*(2+1+1)/8=50%

TABLE 1.1

| EMP.ENAME | EMPL.EMPNAME | Match Score | Match Count |
|---|---|---|---|
| Fred | Fredrick | 70% | 2 |
| | Frederick | 60% | |
| | Hazel | 0% | |
| | Harold | 0% | |
| | Lucio | | |
| Lucy | Fredrick | 0% | 1 |
| | Frederick | 0% | |
| | Hazel | 0% | |
| | Harold | 0% | |
| | Lucio | 60% | |
| Hazem | Fredrick | 0% | 1 |
| | Frederick | 0% | |
| | Hazel | 80% | |
| | Harold | 10% | |
| | Lucio | 0% | |

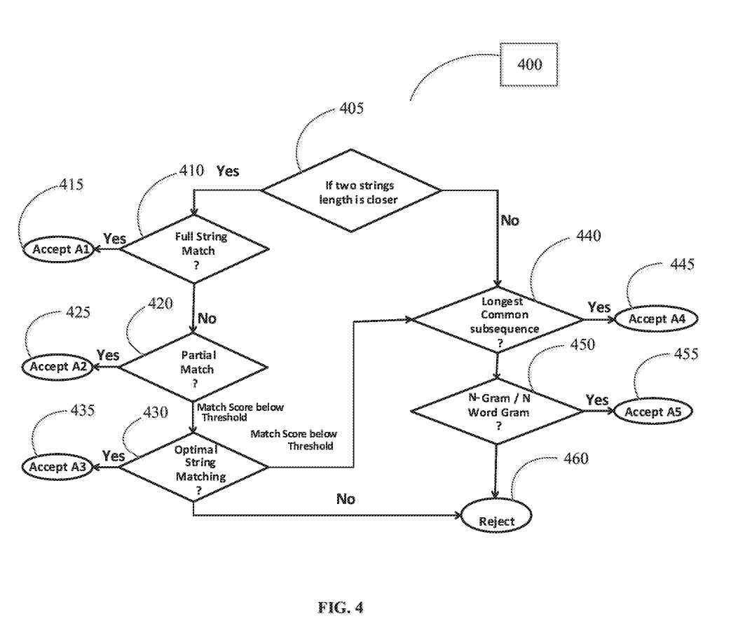

According to one embodiment of the invention, the process of matching entity, attribute and value is repeated for all the groups of data and a plurality relationship scores are computed and thereafter based on the plurality of relationship scores or strength of the relationship or related data, one or more clusters are created. The process of matching entity, attribute and value is repeated for among all the clusters and a plurality of relationship scores are generated. The clusters contains relevant or related data from the different groups. Re-clustering may also be done on the clusters based on the obtained relationship scores, in order to keep related or relevant entities in one cluster. The entity, attributes and values are matched by using one or more soft matching techniques as described in FIG. 4. The plurality of relationship scores so obtained are compared with the predefined score to determine the identity relationships. According to an exemplary embodiment of the invention, a SQL connection or data source SQL1 which has 100 tables/entities and 1400 attributes. The relationships are identified among 100 entities and relationships or related clusters and relationship strength are stored. The clusters may be analyzed to identify some entities as Duplicate entities. The re-clustering may also be done based on an Entity pair relationship strength to keep those entity pairs in a cluster that satisfy a specific range of relationship strength score. Similar process is repeated for other data sources (like SQL2, ORC1 and XML1 etc) and obtained relationship score is compared with the predefined score to determine identity relationship.

FIG. 4 is a flow diagram, illustrating the flow of soft matching techniques 400, according to one or more embodiments. The one or more soft matching techniques may be full match, partial match, optimal string match (ex., fuzzy matching (i.e., compute degree of similarity between two strings such as Levenshtein distance), value-based relation (e.g. dd/mm/yyyy with mm/dd/yyyy), semantic meta-data relation (e.g., words such as home and house are serve as synonyms in some context), proximity analysis (e.g., similarity with neigbhourhood text) and hash function (ex. computing hash value of words)), longest common subsequence, and iterative N-gram technique. The one or more soft matching techniques may be applied in predefined order, which may vary depending upon the type of data sources. The soft matching technique is used to generate one or more clusters of the grouped data and a plurality of relationship scores among the clusters. The soft match is a possibilistic match (rather than probabilistic match). The entity name usually contains strings which is a sequence of characters. The soft techniques, matches two or more strings, wherein each string constitutes one or more words. There are several soft match techniques available. Each one has a certain level of accuracy. Hence, to obtain exhaustive and accurate results one or more techniques are combined to determine the identity relationships.

According to an embodiment of the invention, one of the soft matching technique is full string match technique. The full string match technique matches length of two strings and thereafter character by character in both strings by position and order.

According to an embodiment of the invention, one of the soft matching technique is partial string matching technique 420. For instance, if one part of a string is exactly matched with another string or part of another string then two strings may be partially matched. The part of the string may be words. The words of a string may be split by a space or other special characters. For instance, in two strings viz. String 1 and String 2, String 1 words are compared one by one and with string 2 words. Based on how many percent each word of a string1 is exactly or likely same to another word of a string 2 or in string 2 itself, a weight to that word of the string 1 is assigned. Similarly, string 2 words are compared with string 1 words. Thereafter, an average percentage of each words' weights are calculated, which is the match percentage. According to an exemplary embodiment of the invention, two attributes viz. EMAIL_ADDR of PERSON_DETAILS and EmailAddress of Person for an email address from PERSON_DETAILS Marcus.Rivera@hotmail.com are present, then two possiblistic email address matched may be retrieved from Person: Rivera_Marcus @hotmail.com and Marcus.Cooper@hotmail.com as depicted in table 1.2.

TABLE 1.2

| PERSON_DETAILS.EMAIL_ADDR | Person. EmailAddress | Partial Match |
|---|---|---|
| Split by special characters (. and @) | Split by special characters (. _ and @) | Percentage |
| MARCUS, RIVERA, HOTMAIL, COM | RIVERA, MARCUS, HOTMAIL, COM | 100% |
| MARCUS, RIVERA, HOTMAIL, COM | MARCUS, COOPER, HOTMAIL, COM | 54% |

According to an embodiment of the invention, one of the soft matching technique is an optimal string match technique. In the optimal string match, string matching is based on a string distance for which string distance metrics may be used. The string distance metrics may be categorized into an edit-based distances, n-gram based distances and a hybrid measures. In the edit-based distances, one counts, possibly weighted, one or more fundamental operations necessary to turn one string into another. The one or more fundamental operations may include substitution, deletion, or insertion of a character or transposition of characters. The commonly used edit distance metrics includes Levenshtein, Jaro, Jaro-Wrinker, Monge-Elkan distance Function and Smith-Waterman distance function. For instance, the Levenshtein distance assigns a unit cost to all edit operations (namely insert, delete or substitution) required to convert the first string into second string.

According to an embodiment of the invention, one of the soft matching technique is longest common subsequence. The longest common subsequence technique find length of a longest subsequence present in two sequence of characters or two strings. A subsequence is a sequence that appears in a same relative order, but not necessarily contiguous. For example, “abc”, “abd”, “acd”, “ade”, ‘“adf” etc. are subsequences of “abcdefg” hence a string of length n has 2̂n different possible subsequences. The longest common subsequence is the longest sequence formed by pairing characters from two strings say S1 and S2 while keeping their order intact. Then, a longest common subsequence distance is the number of unpaired characters over both strings. For example: a longest common subsequence between “umbrella” and “membrane” is “mbre” of length 4.

According to an embodiment of the invention, one of the soft matching technique is N-Gram/N-Word Gram Technique. This technique is extensively used in data mining and natural language processing. In text mining, n-gram is a contiguous sequence of N items from a given sequence of text. The N items may be N contiguous characters or N contiguous words in a string. For example, to find soft match between 2 strings we use this technique to find out matches between those. An optimal value of N based is set based on a desired accuracy level. Each N gram words are sorted by characters and compared with the sorted N gram words of other string. Edit distance is used between these sorted strings and to find a percentage of match between the 2 strings. If it does not match, it is reduced to value of N to N−1 and search is performed again. Every time the value of N is reduced, there is a gram-penalty which is deducted from overall matched percentage. According to an exemplary embodiment of the invention, a distances based on n-grams are obtained by comparing the occurrence of n-character sequences between strings. The N-grams are sub-strings of length n from a string. For instance, ‘Infosys’, the 1-grams are ‘I’, ‘n’, ‘f’, ‘o’, ‘s’, ‘y’, ‘s’, 2-grams are ‘In’, ‘nf’, ‘fo’, ‘os’, ‘sy’, ‘ys’, and so on. The N-word grams are strings constituting words with n-gram of each string. Like, ‘Infosys Limited’, 1-word gram is ‘IL’, 2-word gram is ‘In LI’, etc. The n-gram starting at a specific position in a word (these can be named as positional n-grams) may also be considered. A token based string distance functions (such as Jaccard, TF-IDF (Term frequency-Inverse Document Frequency), etc.) are used to compute n-gram similarity. For instance, for an n-gram similarity between two strings is calculated by counting the number of n-grams (or n-word grams) contained in both strings and divide by the average number of n-grams in both strings.

FIG. 4 depicts steps of soft matching performed during an entity match process which involves matching entities, attributes and values match. According to an exemplary embodiment of the invention, If two or more entities are matched using soft match techniques, it starts with matching two strings, if length of two strings is almost close, then following are applied; (i) full string match 410, (ii) partial string match 420 (ex. number of words match), (iii) Optimal string alignment distance functions or optima string matching 430 (ex. Edit (Levenshtein) distance).

In a case wherein both the string lengths have large difference, then in addition to above, following are applied (iv) longest common subsequence 440, (v) n-gram and n-word gram 450 approaches (applied repeatedly with varying n value, like, 1-gram, 2-gram, 3-gram, etc.).

According to an exemplary embodiment of the invention, a weighted convex combination of (i) to (vi) (based on heuristics depend on the application) provides a score/relationship score for soft match. That is, the relationship score S between two strings is computed as:

S=w1*A1+w2*A2+w3*A3+w4*A4+w5*A5,
where w1, w2, w3, w4 and w5 are weights for the corresponding individual scores, and

w1+w2+w3+w4+w5=1

The two entities match is evaluated using

S≥Th,

where Th is a user-defined threshold or threshold score or threshold value and it is a specific to an application under study. If an Entity pairs with matching score S greater than the threshold are considered to be a match indicating the non-obvious relationship between those two strings that representing the two entities; while pairs below the threshold are considered to be non-match indicating that relationship does not exist between the two entities. According to yet another embodiment of the invention, a dynamic weight is assigned during each step the soft matching technique that is, the scoring is dynamic, and it iteratively computes and terminate at a favorable answer. In the above instance, if the full string match 405 is true (that is A1), then the procedure stops and return the result by setting the weights of (i) as 1 and for other weights as zero. Otherwise, the procedure determines the weights for A2, A3, A4 and A5. Here, the approach is a ‘dynamic weighting’ as the weights are determined as the string matching process progresses.

Hence, in FIG. 4, if two string length is closer 405, it is taken ahead for full string match 410. If it matches then it is accepted (A1) 415 and a match score is generated. If it does not match then strings are taken for next soft match technique i.e. partial match 420. If it matches then it is accepted (A2) 425 and a match score is generated by assigning a weight/weightage. If the match score obtained is below a predefined threshold score then it is taken to next soft match technique i.e. optimal string match 430 and again a match score is computed by assigning weight. If the match score obtained is below a predefined threshold score then it taken to next soft match technique i.e. longest common sequence 440 and again a match score is computed by assigning weight. If the match score is above threshold it is accepted (A3) 445. If string does not matches, it is rejected 460. If the match score obtained is below a predefined threshold score then it taken to next soft match technique i.e. N-Gram 450. And similar step of computing a match score by assigning weight is performed. If the match score is above threshold it is accepted (A5) 455. If the match score is below threshold it is rejected 460. The final match score obtained by soft matching technique is relationship score. Hence, the process of soft match search is iterative/repeated for each group of source data to obtain a plurality of relationship scores and based on the same one or more clusters are formed. Similarly, the soft matching techniques are repeated for each cluster of data. The final match scores or relationship scores (as it contains confirmed or relevant relationship information) is generated from each clusters after iterative process of an entity, attribute and value match process using one or more soft matching techniques, is compared with predefined score to determine the final identity relationships.

Hence, the process of identity relationship determination among two or more data entities involves extracting an enterprise data from one or more data sources 202. The data is extracted by establishing a connection with the data source. The process also involves registering the data. The registration process involves registering a connection credentials of the one or more data sources 118. Once connection is established and data is registered then data is extracted by means of one or more adaptors using one or more method depending upon the type of data. The data is extracted in a staging area for further processing. Thereafter, the data is grouped into one or more groups based on one or more predefined criteria 204. Then, a plurality of relationship scores are calculated. The process starts by an entity matching 305. The entity is first matched by exact word, if it doesn't match then it is taken ahead for one or more soft matching techniques 400. The one or more soft matching technique, matches strings in the entity 405. If full string matches 410 and a match score is generated by assigning a weight. If obtained score is below a predefined threshold, then it is taken ahead for partial match 420, if string matches partially, it is accepted 425 and match score is calculated by assigning a weight. If match score is below threshold it is taken ahead for optimal string match 430, if string matches, data is accepted 435 and a match score is calculated by assigning weight, and compared with threshold score. If match score is below threshold score, it is taken ahead for next soft matching technique viz. longest common sequence 440, and if longest common sequences are found then it is accepted 445 and a match score by assigning weight is calculated and compared with the threshold score. If match score is below threshold score then it is taken ahead for next soft matching technique, i.e N-gram/N-word gram 450, if matches are found, a match score is calculated and data is accepted 455. If entity match is found then it is taken ahead for next step of attributes matching 310 by using similar process described above. If attribute doesn't match, data is rejected 320, if attribute matches it is taken ahead for value matching 315 using the similar soft matching techniques described above. If value doesn't match data is rejected 320, if value matches a final match score or relationship score is calculated 330. The weight assignment process is dynamic. The soft matching technique is mentioned in FIG. 4. The above mentioned process is repeated for all groups of data and based on the obtained relationship score one or more clusters are created. The cluster contains related or similar data. Once clusters are formed, then relationship score among clusters are also calculated and a plurality of relationship scores are obtained 206. The plurality of relationship scores are compared with a predefined score to determine identity relationships 208 and relationship is accepted is relationship score is equal or greater than predefined score. If relationship is below predefined score, relationship is rejected. Finally, a report of determined identity relationships is generated 210.

Further, the scores assigned to entities also helps in determining a ‘golden entity identity’ in a particular clusters for normalizing the set of values in an enterprise data. The Golden record identification may be done by choosing the maximum score strings pair in the cluster and choose the longest among these two as the ‘Golden entity identity’. This process of normalization/standardization by replacing a group of entities' representation into a single one provides a better data quality in an organization.

The identity relationship process described herein provides benefit of automation and elimination of manual review wherein identity based relationships among enterprise data entities are easily reproducible.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through one or more processors. These input and output operations may be performed by a processor. The medium readable through the one or more processors may be, for example, a memory, a transportable medium such as a CD, a DVD, a Blu-ray™ disc, a floppy disk, or a diskette. A computer program embodying the aspects of the exemplary embodiments may be loaded onto the one or more processors. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

We claim:

1. A computer-implemented method executed by one or more computing devices for determining identity relationships among two or more enterprise data entities, the method comprising:
extracting, by at least one of the one or more computing devices, an enterprise data from one or more data sources;
grouping, by at least one of the one or more computing devices, the extracted enterprise data into one or more groups based on one or more predefined criteria;
computing, by at least one of the one or more computing devices, a plurality of relationship scores, wherein the computing comprises:
matching one or more data entities in the grouped enterprise data;
calculating a plurality of relationship scores of the matched entities by using one or more soft matching techniques;
clustering the data into one or more clusters based on the calculated relationship score;
obtaining a plurality of relationship scores among the clusters by repeating process of relationship score calculation; and
determining, by at least one of the one or more computing devices, the identity relationships by comparing the computed plurality of relationship scores generated among the clusters with a predefined score.

2. The method as claimed in claim 1, further comprising registering, by at least one of the one or more computing devices, the enterprise data received from the one or more data sources before extracting the data.

3. The method as claimed in claim 1, wherein matching one or more data entities in the grouped enterprise data comprises matching one or more entities, attributes and values.

4. The method as claimed in claim 1, wherein the one or more soft matching techniques are selected from the group consisting of full match, partial match, optimal string match, longest common subsequence, and iterative N-gram technique.

5. The method as claimed in claim 1, wherein the enterprise data is extracted from the one or more data sources by establishing a connection with the one or more data sources.

6. The method claimed in claim 1, further comprising assigning, by at least one of the one or more computing devices, a dynamic weight during each step of the soft matching techniques.

7. The method claimed in claim 1, wherein determining the identity relationships comprises accepting or rejecting the relationships based on the comparison with the predefined score.

8. The method claimed in claim 1, further comprising generating a report of the determined identity relationships.

9. A system for identity relationships determination among two or more enterprise data entities, the system comprising:
an extraction engine;
a grouping engine;
a computation engine;
an identity relationship determination engine;
one or more processors; and
one or more memories operatively coupled to at least one of the one or more processors and having instructions stored thereon that, when executed by at least one of the one or more processors, cause at least one of the one or more processors to:
extract, at the extraction engine, an enterprise data from one or more data sources;
group, at the grouping engine, the extracted enterprise data into one or more groups based on one or more predefined criteria;
compute, at the computation engine, a plurality of relationship scores, wherein the compute step comprises:
matching one or more data entities in the grouped enterprise data;
calculating a plurality of relationship scores of the matched entities by using one or more soft matching techniques;
clustering the data into one or more clusters based on the calculated relationship score;
obtaining a plurality of relationship scores among the clusters by repeating process of relationship score calculation; and
determining, at the identity relationship determination engine, the identity relationships by comparing the computed plurality of relationship scores generated among the clusters with a predefined score.

10. The system as claimed in claim 9, further comprising a registration engine configured to register the enterprise data received from the one or more data sources before extracting the data.

11. The system as claimed in claim 9, wherein matching one or more data entities in the grouped enterprise data comprises matching one or more entities, attributes and values.

12. The system as claimed in claim 9, wherein the one or more soft matching techniques are selected from the group consisting of full match, partial match, optimal string match, longest common subsequence, and iterative N-gram technique.

13. The system as claimed in claim 9, wherein the enterprise data is extracted from the one or more data sources by establishing a connection with the one or more data sources.

14. The system claimed in claim 9, further comprising a weight assignment engine, configured to assign a dynamic weight during each step of the soft matching techniques.

15. The system claimed in claim 9, wherein determining the identity relationships comprises accepting or rejecting the relationships based on the comparison with the predefined score.

16. The system claimed in claim 9, further comprising a report generation engine configured to generate a report of the determined identity relationships.

17. A non-transitory computer-readable medium storing computer-readable instructions that, when executed by one or more computing devices, cause at least one of the one or more computing devices to:
extract, at the extraction engine, an enterprise data from one or more data sources;
group, at the grouping engine, the extracted enterprise data into one or more groups based on one or more predefined criteria;
compute, at the computation engine, a plurality of relationship scores, wherein the compute step comprises:
matching one or more data entities in the grouped enterprise data;
calculating a plurality of relationship scores of the matched entities by using one or more soft matching techniques;
clustering the data into one or more clusters based on the calculated relationship score;
obtaining a plurality of relationship scores among the clusters by repeating process of relationship score calculation; and
determining, at the identity relationship determination engine, the identity relationships by comparing the computed plurality of relationship scores generated among the clusters with a predefined score.
